(19) United States
(12) Patent Application Publication
(10) Pub. No.: US 2012/0318935 A1
(43) Pub. Date: Dec. 20, 2012

(54) MULTIPLE TUBE DIAMETER RETAINING INSERT

(76) Inventor: Steven M. Benedetti, Sterling Heights, MI (US)

(21) Appl. No.: 13/162,117

(22) Filed: Jun. 16, 2011

(51) Int. Cl. F16L 3/08; F16B 2/10

(52) U.S. Cl. 248/74.1; 24/457

(57) ABSTRACT

A multiple size member retaining insert includes a body having a passageway through opposed body side walls and a cavity between the side walls. A clamp assembly is rotatably connected to the side walls and movable in the cavity. The clamp assembly includes a curved first clamp arm rotated from a receiving position to a retention position, both within the passageway. An oppositely curved second clamp arm rotates from a release position outside the passageway to a clamping position within the passageway. An arm hinge integrally connecting the first and second clamp arms permits the clamp arms to rotate independently. Clamp assembly first and second hinge pins are individually rotatably received in the side walls. A hinge pin rotational axis also defines an arm hinge rotational axis. The second clamp arm ratchets against a toothed member to retain a tube between the first and second clamp arms.

### FIELD

The present disclosure relates to clips or fasteners used to retain tubing and cabling in automobile vehicles.

### BACKGROUND

This section provides background information related to the present disclosure which is not necessarily prior art.

Fasteners used to retain components such as tubing in automobile vehicles commonly include legs with deflectable wings that permit the fastener legs to be inserted and retained in apertures created in a panel of the vehicle. One or more components broadly referred to herein as tubing can include wiring or cables, vacuum system tubes, fuel tubes, hydraulic/brake fluid tubes, windshield washer fluid tubes, wiring harnesses, and the like can be inserted into individual fastener slots or passageways and retained using a flexible member that deflects to receive the component and elastically rebounds to a non-deflected condition to retain the component.

It is common in the automobile vehicle industry to use multiple different fasteners in different locations around the engine compartment and the vehicle chassis to support multiple sizes of components at different vehicle locations. This requires strict tracking of the individual fasteners to ensure the correct fastener is installed at each location, and further requires additional costs to receive, store, inventory, and install each of the multiple size member fasteners. Common fasteners used for this function do not provide the additional capability of reducing vibration or sound transfer that the various tubes or members may create by transitioning to different areas of the vehicle, for example engine compartment vibration may be transferred to the passenger compartment.

### SUMMARY

This section provides a general summary of the disclosure, and is not a comprehensive disclosure of its full scope or all of its features.

According to several embodiments, a multiple size member retaining fastener includes a body having a passageway created through opposed first and second body side walls and a cavity between the first and second body side walls. A clamp assembly is movable in the cavity between the first and second side walls. The clamp assembly includes a first clamp arm rotated between a member receiving position and a member retention position. A second clamp arm is rotated between a release position located outside the passageway and a clamping position located within the passageway. An arm hinge integrally connects the first clamp arm to the second clamp arm permitting the first and second clamp arms to rotate independently of each other.

According to other embodiments, a multiple size member retaining fastener includes a body having a passageway created through opposed first and second body side walls and a cavity between the first and second body side walls. A clamp assembly is rotatably connected to the first and second side walls and is movable in the cavity between the first and second side walls. The clamp assembly includes a curved first clamp arm rotatable from a member receiving position to a member retention position, both positions located within the passageway. A second clamp arm oppositely curved with respect to the first clamp arm is rotatable from a release position located outside the passageway to a clamping position located within the passageway. An arm hinge integrally connecting the first clamp arm to the second clamp arm operates to permit the first and second clamp arms to rotate independently of each other. First and second hinge pins extending from the clamp assembly are individually rotatably received in one of the first or second side walls. A common longitudinal rotational axis of the first and second hinge pins also defines a rotational axis of the arm hinge.

According to further embodiments, the body has a passageway created through opposed first and second body side walls having a spacing predetermined to receive one of multiple members each having different diameters, and a cavity between the first and second body side walls. A clamp assembly is rotatably connected to the first and second side walls and movable in the cavity between the first and second side walls. The clamp assembly includes a curved first clamp arm rotatable from a member receiving position to a member retention position, both positions located within the passageway. A second clamp arm is oppositely curved with respect to the first clamp arm and is rotatable from a release position located outside the passageway to a clamping position located within the passageway. An arm hinge integrally connecting the first clamp arm to the second clamp arm permits the first and second clamp arms to rotate independently of each other. First and second hinge pins extending from the clamp assembly are individually rotatably received in one of the first or second side walls. A common longitudinal rotational axis of the first and second hinge pins also defines a rotational axis of the arm hinge. When the first clamp arm receives one of the members in the retention position and the second clamp arm is rotated to the clamping position, both the first and second clamping arms contact the member to frictionally retain the member in the passageway.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front elevational perspective view of a multiple size member retaining fastener of the present disclosure;

FIG. 2 is a front elevational perspective view of the retaining fastener of FIG. 1 with a tube received in a clamp assembly;

FIG. 3 is a front elevational perspective view of the retaining fastener of FIG. 2 following closure of the clamp assembly;

FIG. 4 is a top plan view of the retaining fastener of FIG. 2;

FIG. 5 is a partial cross sectional front elevational view taken at section 5 of FIG. 4;

FIG. 6 is a front elevational view of the retaining fastener of FIG. 3 in use with a maximum diameter tube;

FIG. 7 is a top plan view of the retaining fastener of FIG. 6;

FIG. 8 is a front elevational view similar to FIG. 6 of the retaining fastener in use with a minimum diameter tube;

FIG. 9 is a top plan view of the retaining fastener of FIG. 8;

FIG. 10 is a front right perspective view of a rotatable clamp assembly of the present disclosure;

FIG. 11 is a front elevational view of the retaining fastener of FIG. 3 having a front wall portion removed for visibility of a toothed member;

FIG. 12 is a top plan view similar to FIG. 4 of a further embodiment retaining fastener engaged with a largest diameter tube;

FIG. 13 is a cross sectional front elevational view taken at section 13 of FIG. 12;

FIG. 14 is a top plan view of the fastener of FIG. 12 showing engagement with an intermediate diameter tube;

FIG. 15 is a cross sectional front elevational view taken at section 15 of FIG. 14;

FIG. 16 is a top plan view of the fastener of FIG. 12 showing engagement with a smallest diameter tube; and

FIG. 17 is a cross sectional front elevational view taken at section 17 of FIG. 16.

Corresponding reference numerals indicate corresponding parts throughout the several views of the drawings.

### DETAILED DESCRIPTION

Example embodiments will now be described more fully with reference to the accompanying drawings.

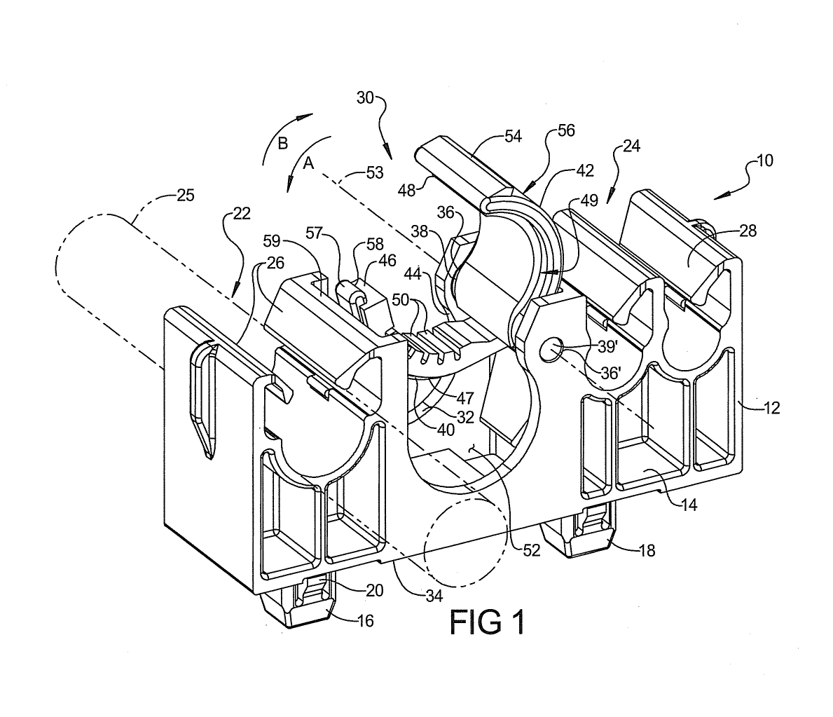

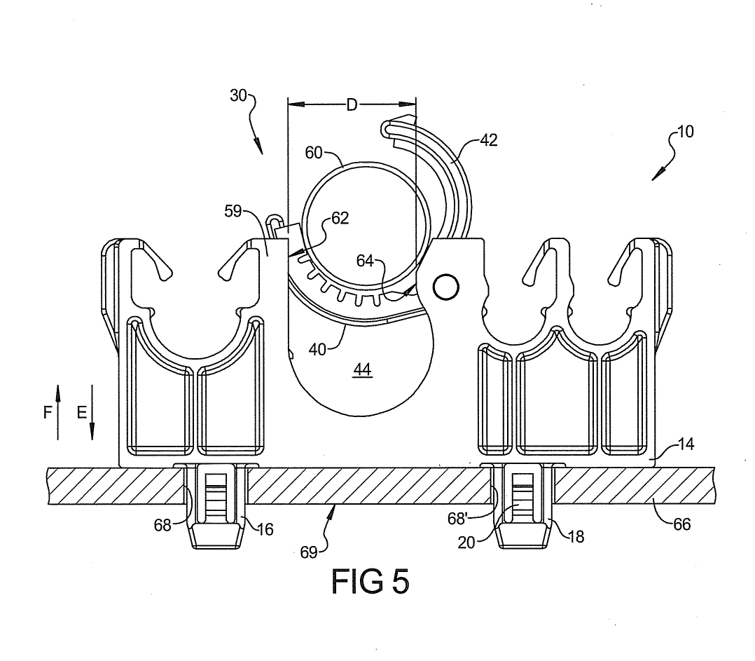

Referring to FIG. 1, a multiple tube diameter retaining insert or multiple size member retaining fastener 10 includes a molded polymeric body 12 having a lower body plate 14 which supports multiple member connector assemblies. First and second connector legs 16, 18 extend downwardly from the body plate 14 which each have one or more deflectable wings 20 used to hold retaining fastener 10 in contact with a body panel or plate of an automobile vehicle shown and described in better detail in reference to FIG. 5. Retaining fastener 10 can include a first member connector assembly 22 and in some embodiments a second member connector assembly 24 which individually receive one or more members 25 of a predetermined size or limited range of sizes. The members 25 are retained by a first set of retention fingers 26 for the first member connector assembly 22, and/or by an individual second retention finger 28 when the member size is below a predetermined size.

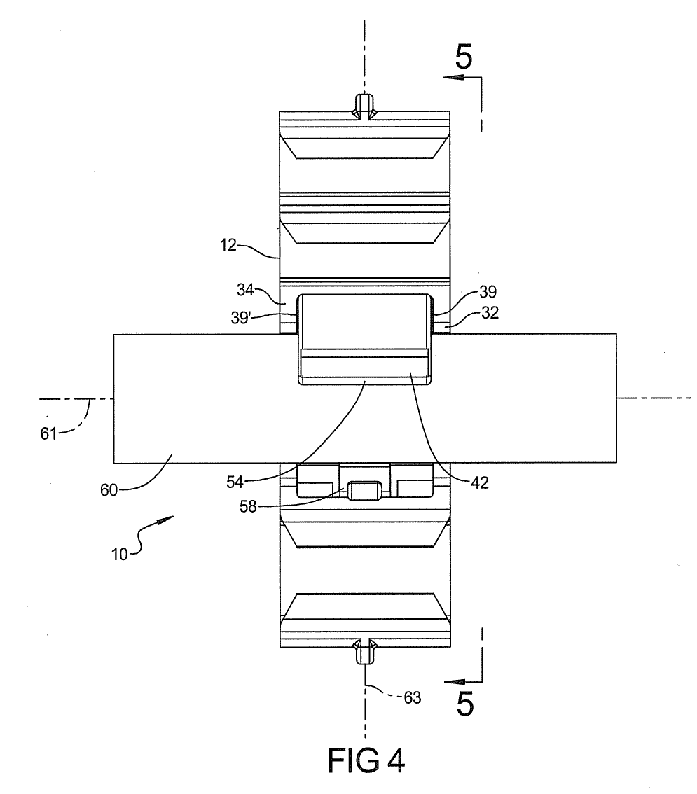

To provide for retention of a range of member sizes using a single connection, a rotatable clamp assembly 30 is provided in the present design which allows substantially any member size that can be retained by either of the first or second member connector assemblies 22 or 24, plus larger member sizes, to be clamped therein. Clamp assembly 30 is positioned between first and second side walls 32, 34 of main body 12 which each include a pin aperture 36, 36′. A hinge pin assembly 38 has individual hinge pins 39 (shown and described in reference to FIG. 4) that are rotatably received in each of the pin apertures 36, 36′. Clamp assembly 30 also includes a first clamp arm 40 and a second clamp arm 42 one of which is fixed to and the other of which is rotatably connected to hinge pin assembly 38. Clamp assembly 30 rotates from the open position shown into alignment with a horseshoe-shaped passageway 44 created in and co-axially aligned through both first and second side walls 32, 34.

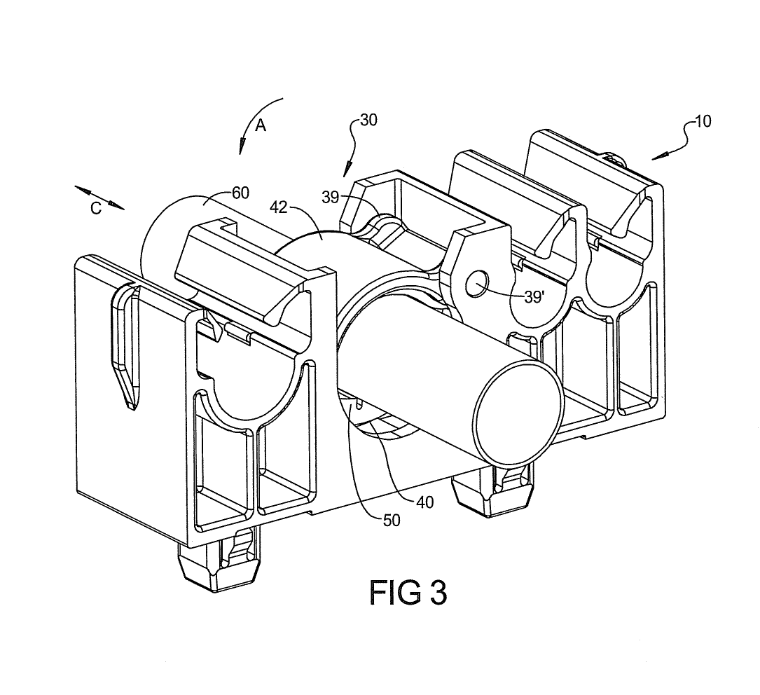

First clamp arm 40 is arc-shaped or partially-circular and made of a rigid plastic such as polyoxymethylene in a first molding “shot” of a two-shot molding process. First clamp arm 40 includes an elastically compressible, deflectable polymeric liner 46 made for example from a thermoplastic elastomer (TPE) molded in a second “shot” that physically connects or bonds liner 46 to clamp arm 40 on an inner, semi-circular or curved surface 47 of clamp arm 40 which faces second clamp arm 42. Second clamp arm 42 is also semi-circular or curved and similarly includes a compressible polymeric liner 48 made for example from TPE molded in a second “shot” and integrally connected to an inner partially-circular or curved surface 49 of second clamp arm 42 that faces first clamp arm 40. The elastically deflectable material of liners 46, 48 provides for acoustic or vibration isolation between the tube or member received between first and second clamp arms 40, 42 and a vehicle panel to which body 12 is connected. The elastically deflectable material of liners 46, 48 increases a frictional retention capability of clamp assembly 30 in services where longitudinal movement of the tube or member is undesirable. Multiple, elastically flexible fingers 50 can also be included with either or both of plastic liners 46, 48 to further enhance the frictional grip. Prior to receiving a member such as a tube, first clamp arm 40 is initially received in a cavity 52 between first and second side walls 32, 34 and positioned in passageway 44 as shown in greater detail in FIG. 3.

Each of the first and second member connector assemblies 22, 24, and passageway 44 of fastener 10 provide support for components or members such as tubing or cables, including vacuum tubes, fuel tubes, hydraulic/brake fluid tubes, windshield washer fluid tubes, wiring harnesses, cables, and the like, hereinafter collectively referred to as a member or members. Although a single passageway 44 is shown, any or all of the first and second member connector assemblies 22, 24 can be replaced by a passageway 44 having a clamp assembly 30. Therefore, retaining fasteners 10 of the present disclosure can include more than one clamp assembly 30 used to clamp one or more members.

Each of the first and second clamp arms 40, 42 of clamp assembly 30 can be independently rotated, from the open position shown, in a closing direction “A” with respect to an axis of rotation 53 of hinge pin assembly 38. Once closed about a member, clamp assembly 30 is thereafter prevented from moving away from a closed/clamped position (shown in FIG. 3) in an opening direction “B” by a raised retention member 54 created on an outer partially-circular or curved surface 56 of second clamp arm 42. A curved, toothed member 57 is positioned opposite to first and second hinge pins 36, 36′ 57 having multiple teeth 58. Raised retention member 54 successively “ratchets” into engagement with one of a plurality of teeth 58 positioned proximate to a wall 59 oppositely positioned with respect to hinge pin assembly 38. Raised retention member 54 “ratchets” until an outer surface of the member is contacted by liner 48.

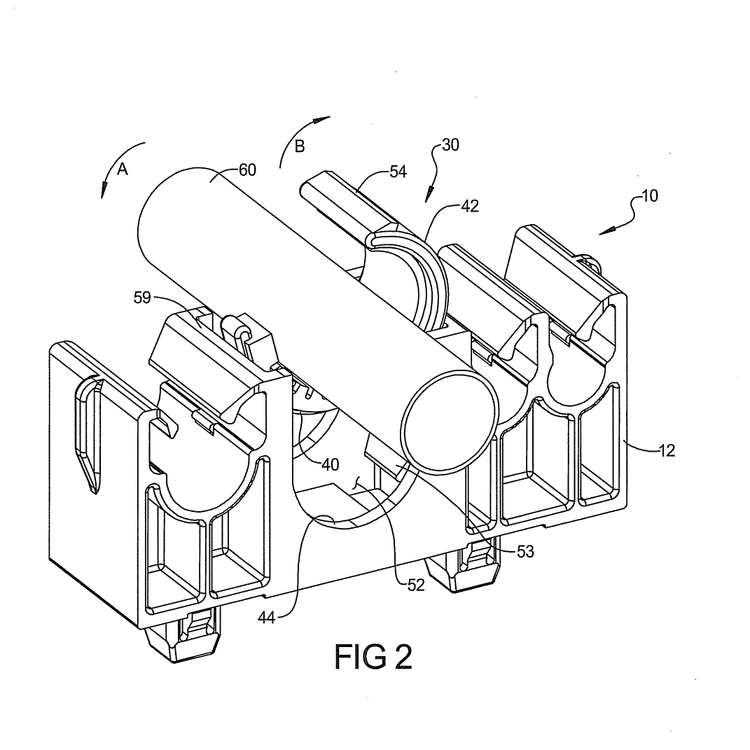

Referring to FIG. 2, a first member 60 is shown positioned in clamp assembly 30 with clamp assembly 30 in the open position. The open position of clamp assembly 30 has first clamp arm 40 rotated into cavity 52 in the closing direction “A”. Second clamp arm 42 is rotated free of cavity 52 and away from first clamp arm 40 in the opening direction ‘B”. First member 60 can be inserted between first and second clamp arms 40, 42 by axial longitudinal displacement or by installation between wall 59, and second clamp arm 42. A wall or contact member 53, which is integrally included with body 12 within cavity 52, is positioned to be contacted by first clamp arm 40 thereby defining a maximum rotation position for first clamp arm 40 when clamp assembly 30 is subsequently rotated to a closed/clamped position which is shown and described in reference to FIG. 3.

Referring to FIG. 3 and again to FIG. 2, after first member 60 is in position clamp assembly 30 is rotated to the closed/clamped position shown. Second clamp arm 42 is rotated with respect to first and second hinge pins 39, 39’ in the closing direction “A” until second clamp arm 42 ratchets into contact with first member 60 such that fingers 50 bend or partially compress to frictionally retain first member 60 against axial/longitudinal movement in an axial direction “C”.

Referring to FIG. 4, second clamp arm 42 is shown prior to closing about first member 60 and prior to raised retention member 54 contacting a curved and toothed member 57 having multiple teeth 58. First hinge pin 39 of hinge pin assembly 38 is rotatably received in first side wall 32 and second hinge pin 39′ is rotatably received in second side wall 34. A longitudinal axis 61 of first member 60 is oriented substantially perpendicular to a longitudinal axis 63 of body 12.

Referring to FIG. 5, with first member 60 in contact with first clamp arm 40 a largest diameter represented by a first member 60a that can be accommodated is defined by a spacing “D” between opposing first wall face 62 of wall 59 and a second wall face 64. Retaining fastener 10 is shown after connection in a body connecting direction “E” to a body panel 66. First and second connector legs 16, 18 are frictionally received in bores 68, 68′ created in body panel 66. Deflectable wings 20 deflect during installation into bores 68, 68′. Deflectable wings 20 are positioned to elastically rotate into engagement with a lower face 69 of body panel 66 by outward rotation after insertion through bores 68, 68′ to help retain retaining fastener 10 in contact with body panel 66. Deflectable wings 20 thereafter resist removal of body 12 in a body removal direction “F”.

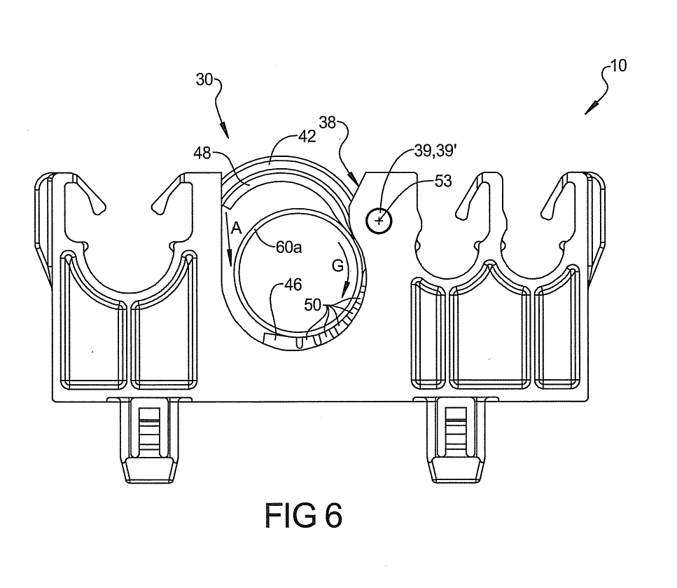

Referring to FIG. 6, first clamp arm 40 has been rotated to a furthest extent into passageway 44 in the closing direction “A” by rotation about axis of rotation 53 of hinge pin assembly 38. First member 60a, which is depicted as a maximum diameter tube or maximum cross sectional area member that can be retained, therefore contacts a maximum quantity of fingers 50 of liner 46. Fingers 50 can each elastically compress with respect to their longitudinal axis, but can also bend or deflect non-axially, for example in a direction “G” as clamping pressure is applied by second clamp arm 42 and liner 48. Liner 48 is shown having no fingers 50 however liner 48 can also include one or more fingers 50.

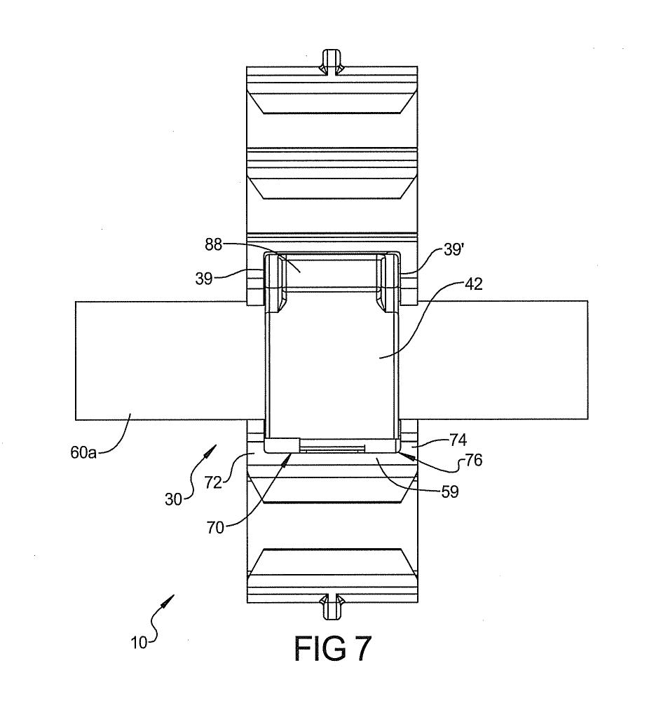

Referring to FIG. 7, clamp assembly 30 is shown after ratcheting second clamp arm 42 to its closed position. Second clamping arm 42 has an end face 70 that slidably fits between opposed legs 72, 74 extending from wall 59. End face 70 is also rotatably received in a cavity defined between opposed legs 72, 74 and a wall face 76 of wall 59. Clearance to ratchet second clamp arm 42 into contact with multiple different sizes of tubes or other members is therefore provided for second clamping arm 42.

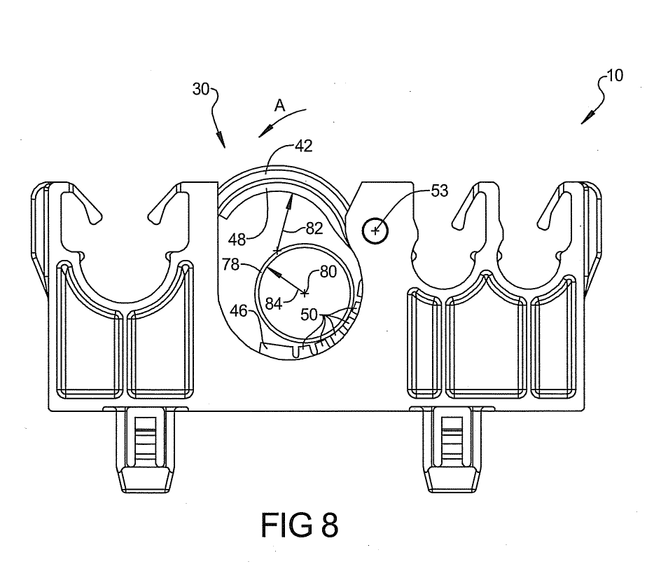

Referring to FIG. 8 and again to FIG. 6, a member 78 is shown having a smallest diameter that can be retained by retaining fastener 10. Member 78 can contact as few as one of the fingers 50 of each of the liners 46, 48 when clamping pressure is subsequently applied by second clamp arm 42 and liner 48. Due to its smaller diameter, a longitudinal axis 80 of member 78 is positioned below and further to the right (as viewed in FIG. 8) compared to longitudinal axis 61 of member 60a, therefore second clamp arm 42 must be rotated further in the closing direction “A” to provide contact between liner 48 and member 78 than to contact member 60a. The smallest diameter tube or member capable of being retained by retaining fastener 10 is based in part on a radius of curvature 82 of liners 46, 48, which cannot exceed a radius of curvature 84 of the outer wall of member 78.

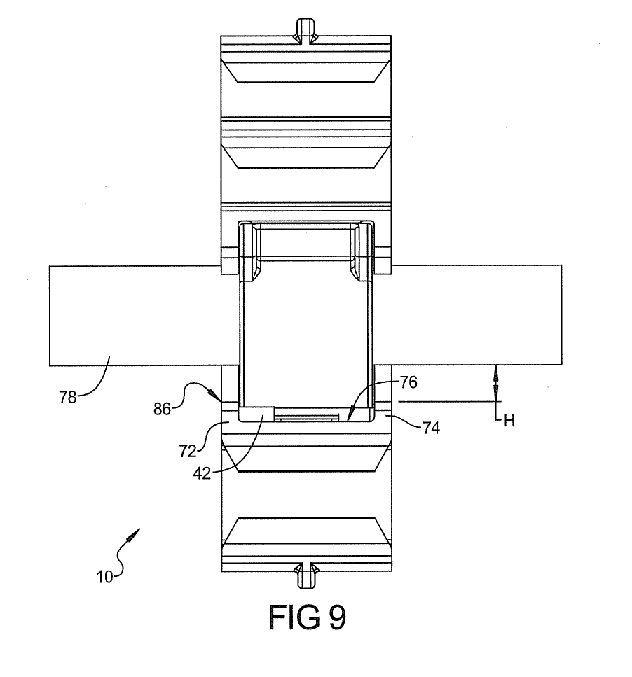

Referring to FIG. 9, when the smallest diameter tube or member 78 is grasped in retaining fastener 10, a spacing “H” is maximized between member 78 and an inner edge 86 of both opposed legs 72, 74. Again, clearance is provided between second clamp arm 42 and wall face 76 of wall 59 for ratcheting/rotation of second clamp arm 42.

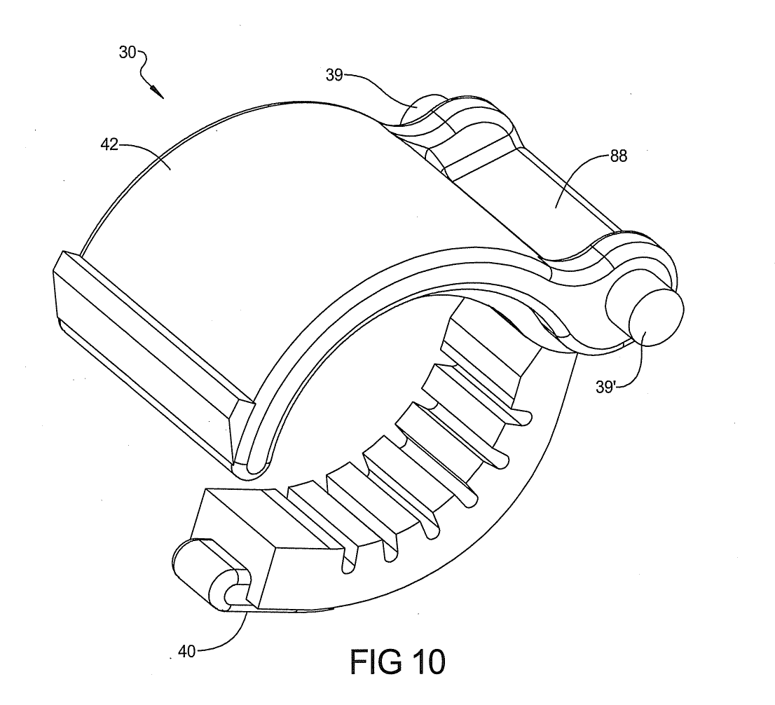

Referring to FIG. 10 and again to FIG. 1, clamp assembly 30 has both first and second clamp arms 40, 42 integrally and homogeneously connected by an arm hinge 88, which acts similar to a living hinge to permit the first and second clamp arms 40, 42 to rotate independently toward or away from each other. According to several embodiments, arm hinge 88 is simultaneously created during the same molding process that creates first and second clamp arms 40, 42 and permits multiple independent rotations of both the first and second clamp arms 40, 42. The axis of rotation 53 of hinge pin assembly 38 is co-axially aligned through both first and second hinge pins 39, 39′ and is coaxially aligned with an axis of rotation 90 of arm hinge 88. This ensures that during rotation of second clamp arm 42 the raised retention member 54 of second clamp arm 42 will align with and engage individual ones of the teeth 58 of toothed member 57.

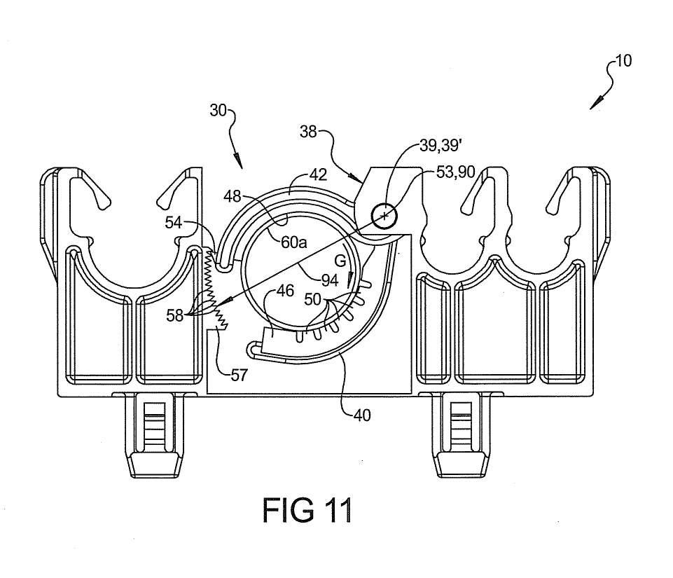

Referring to FIG. 11 and again to FIGS. 1, 3 and 7, first clamp arm 40 rotates freely past individual ones of the teeth 58 of toothed member 57 as first clamp arm 40 is rotated in the closing direction “A” from the member receiving position shown in FIG. 1 to the member retention position shown in FIG. 3. The second clamp arm 42 includes tooth engagement member 54 which sequentially engages individual ones of the teeth 58 to ratchet closed the second clamp arm 42 about the member 60, 60a, or 70. The origin of a radius of curvature 94 of toothed member 57 is defined by the axis of rotation 90 of arm hinge 88 to ensure engagement of any of the teeth 58 by raised retention member 54. Toothed member 57 is fixed to or integrally connected to wall face 76 of wall 59.

A multiple size member retaining fastener 10 includes the following components and operates as follows. Body 12 has tube or member receiving passageway 44 created through the opposed first and second body side walls 32, 34. Passageway 44 has spacing “D” predetermined to receive one of multiple members 60, 60a, 70 each having different diameters, and cavity 52 between the first and second body side walls 32, 34. Clamp assembly 30 is rotatably connected to the first and second side walls 32, 34 and is movable in the cavity 52 between the first and second side walls 32, 34. The clamp assembly includes curved first clamp arm 40 which is rotatable from a member receiving position (shown in FIG. 1) to a member retention position (shown in FIG. 3) both positions located within the passageway 44. Second clamp arm 42 is oppositely curved with respect to the first clamp arm 40 such that a concave shaped surface of each clamp arm faces the other clamp arm. Second clamp arm 42 is rotatable from a release position located outside the member passageway (shown in FIG. 1) to a clamping position located within passageway 44 (shown in FIGS. 3 and 11).

Arm hinge 88 integrally connects the first clamp arm 40 to the second clamp arm 42 and permits the first and second clamp arms 40, 42 to rotate independently of each other. First and second hinge pins 39, 39′ extend co-axially and outwardly from the clamp assembly 30. The first and second hinge pins 39, 39′ are individually, rotatably received in hinge pin apertures 36, 36′ of one of the first or second side walls 32, 34. The common longitudinal rotational axis 53 of the first and second hinge pins 39, 39′ also defines and is co-axial with respect to the axis of rotation 90 of the arm hinge 88. When the first clamp arm 40 receives one of the members 60, 60a, 70 in the member retention position and the second clamp arm 42 is thereafter rotated to the clamping position, both the first and second clamp arms 40, 42 contact either member 60, 60a or 70 to frictionally retain the member in the passageway 44. The elastically deflectable material of the liners 46, 48 connected to the first and second clamp arms 40, 42 directly contact the member 60, 60a or 70 in the fastener clamped and locked position. It is noted members 60, 60a or 70, depicted as tubes, can be any of a tube, wire, cable, rod, wiring harness, or the like.

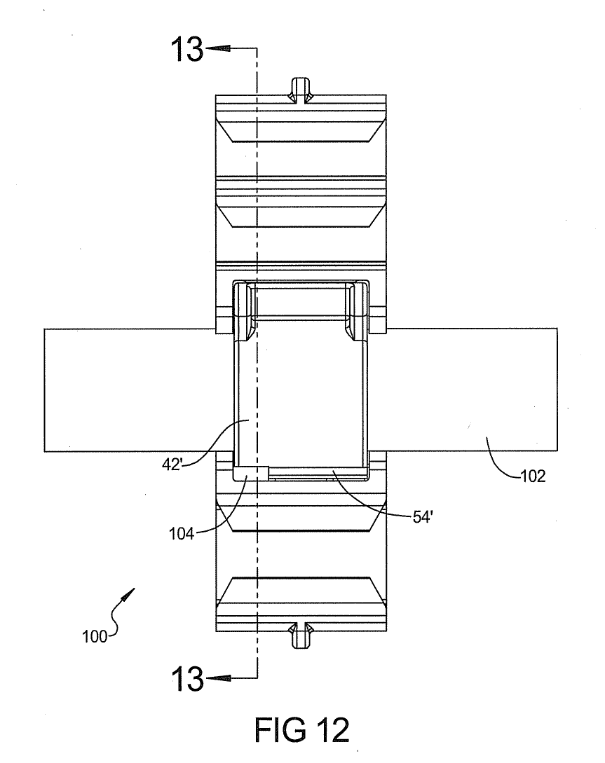

Referring to FIG. 12, according to further embodiments a member retaining fastener 100 is modified from member retaining fastener 10 to include three (3) individual teeth in lieu of multiple teeth 58 and to accommodate three (3) distinct sizes or 3 diameter ranges of tubing. Raised retention member 54′ extends for an entire width of second clamp arm 42′. When second clamp arm 42′ is rotated into contact with a first or largest diameter tube 102, the raised retention member 54′ frictionally engages with a first or upper tooth 104 which is in a staggered position toward a first lateral end of second clamp arm 42′.

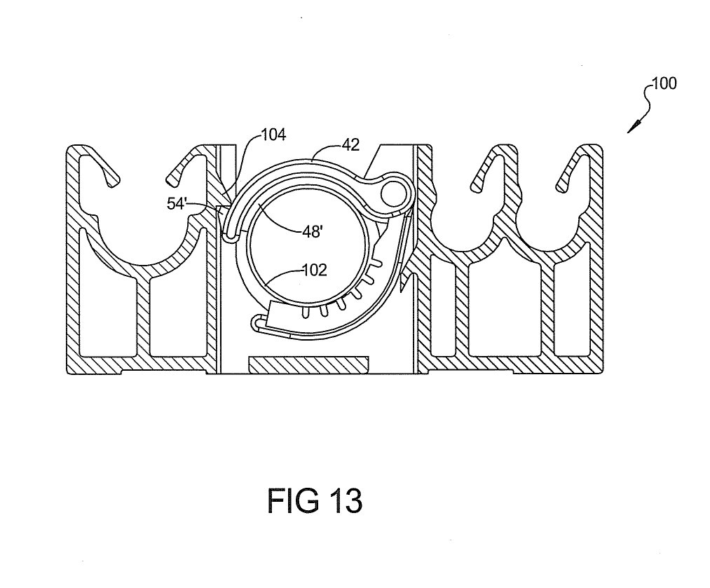

Referring to FIG. 13 and again to FIG. 12, as compressible polymeric liner 48′ contacts largest diameter tube 102, a contact face of upper tooth 104 is positioned to engage the raised retention member 54′. Minor differences in the diameter of largest diameter tube 102 can be accommodated by elastic deflection of compressible polymeric liner 48′.

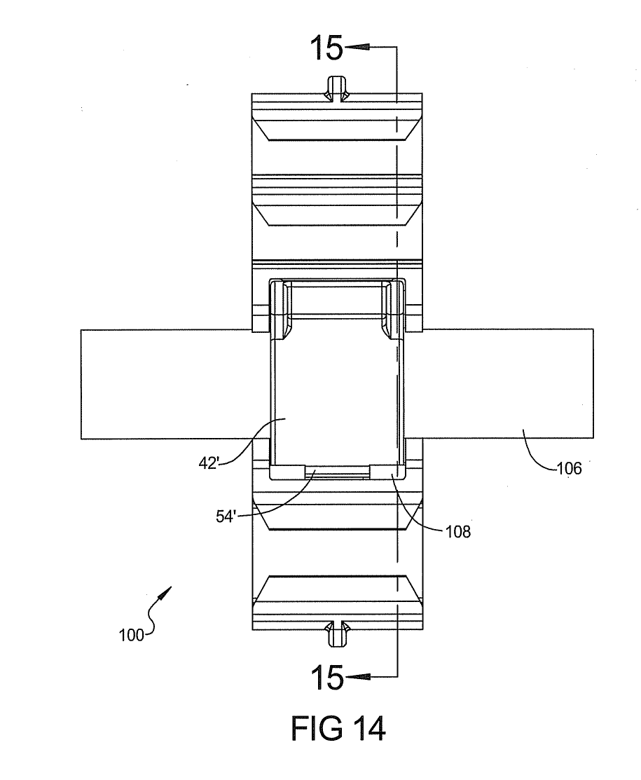

Referring to FIG. 14, member retaining fastener 100 is modified such that when second clamp arm 42′ is rotated into contact with a second or medium diameter tube 106, the raised retention member 54′ rotates past upper tooth 104 and frictionally engages with a second or middle tooth 108 which is staggered toward an opposite second lateral end of second clamp arm 42′ with respect to first or upper tooth 104.

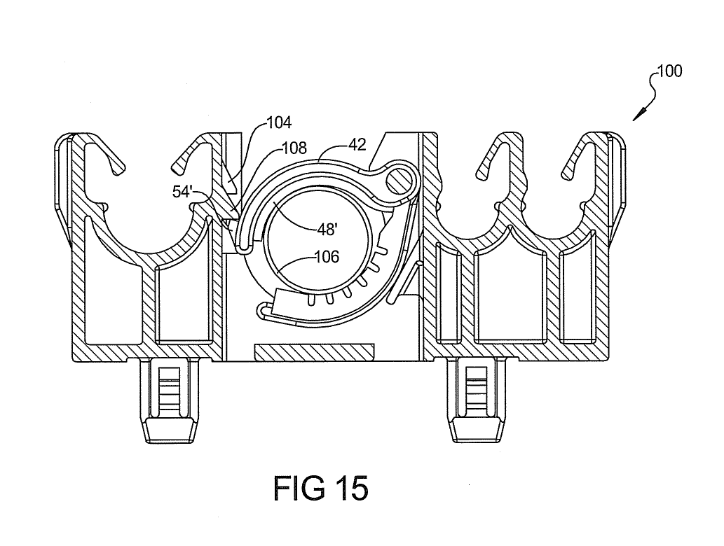

Referring to FIG. 15 and again to FIG. 14, as compressible polymeric liner 48′ contacts medium diameter tube 106, a contact face of middle tooth 108 is positioned to engage the raised retention member 54′. Again, minor differences in the diameter of medium diameter tube 106 can be accommodated by elastic deflection of compressible polymeric liner 48′.

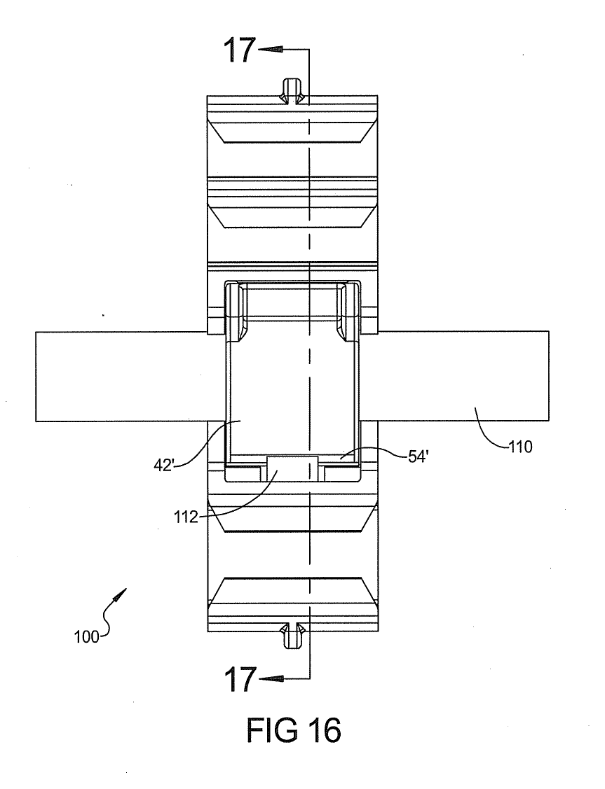

Referring to FIG. 16, member retaining fastener 100 is modified such that when second clamp arm 42′ is rotated into contact with a third or smallest diameter tube 110, the raised retention member 54′ rotates past both upper tooth 104 and middle tooth 108 and frictionally engages with a third or lower tooth 112 which is laterally positioned between first tooth 104 and second tooth 108.

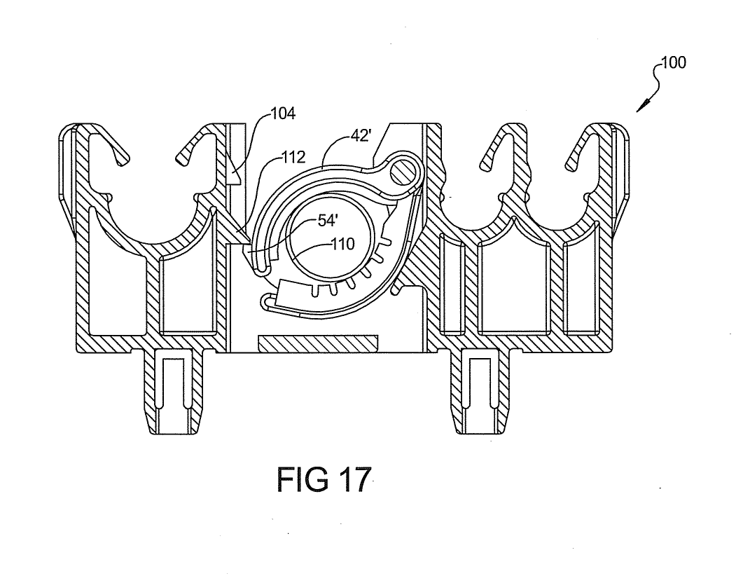

Referring to FIG. 17 and again to FIG. 16, as compressible polymeric liner 48′ contacts smallest diameter tube 110, a contact face of lower tooth 112 is positioned to engage the raised retention member 54′. Again, minor differences in the diameter of smallest diameter tube 110 can be accommodated by the elastic deflection of compressible polymeric liner 48′.

Member retaining fasteners 10 and retaining fasteners 100 of the present disclosure offer several advantages. These include but are not limited to: (1) a member retaining fastener that has two integrally connected but independently rotatable clamping arms having a first arm that receives and a second arm that retains a member between the clamping arms; (2) a two-shot molded member retaining fastener is provided with each of the clamping arms to capture the member between elastically deflectable plastic liners integrally connected to the inner sides of the curved or semi-circular plastic arms, therefore the arms remain substantially rigid while the liners can deflect to change a frictional contact force applied to the member; (3) fingers provided with the plastic liners can either compress and/or bend laterally to further grip the member; (4) the fastener includes a first hinge pin assembly allowing rotation of the entire clamp assembly 30, and an arm hinge that allows independent rotation motion of the first and second arms; and 5) two clamp arms are provided that independently rotate about a common axis of rotation having the second clamp arm ratcheting into contact against teeth 58 of toothed member 57, or against upper tooth 104, middle tooth 108, or lower tooth 112 providing multiple retention positions of the second clamp arm 42, 42′ depending on a diameter (or size) of a tube or member gripped between the two clamp arms.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. Although tubes are shown and described herein for retention by member retaining fasteners 10, other items such as cables, cable banks, rods and the like can also be retained by member retaining fasteners 10. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure.

What is claimed is:

1. A multiple size member retaining fastener, comprising:
a body having a passageway created through opposed first and second body side walls and a cavity between the first and second body side walls; and
a clamp assembly movable in the cavity between the first and second side walls, the clamp assembly including:
a first clamp arm rotated between a member receiving position and a member retention position;
a second clamp arm rotated between a release position located outside the passageway and a clamping position located within the passageway; and
an arm hinge integrally connecting the first clamp arm to the second clamp arm permitting the first and second clamp arms to rotate independently of each other.

2. The multiple size member retaining fastener of claim 1, further including first and second hinge pins extending from the clamp assembly, the first and second hinge pins rotatably connecting the clamp assembly to the body and permitting the clamp assembly to rotate within the cavity.

3. The multiple size member retaining fastener of claim 2, further including a common longitudinal rotational axis of the first and second hinge pins which further defines a rotational axis of the arm hinge.

4. The multiple size member retaining fastener of claim 2, wherein the clamp assembly is rotatably supported to each of the first and second side walls by one of the first and second hinge pins.

5. The multiple size member retaining fastener of claim 2, wherein each of the first and second side walls includes a pin receiving aperture rotatably receiving one of the first or second hinge pins.

6. The multiple size member retaining fastener of claim 2, further including a toothed member having multiple engagement teeth positioned between the first and second side walls and oppositely positioned across the passageway from the first and second hinge pins, the first clamp arm including a tooth engagement member independently ratcheting with one of the multiple engagement teeth to lock a member between the first and second clamp arms.

7. The multiple size member retaining fastener of claim 1, wherein the second clamp arm is oppositely curved with respect to the first clamp arm and at least one of the first and second clamp arms further includes an integrally connected liner of an elastically deflectable material on a concave shaped side.

8. The multiple size member retaining fastener of claim 6, wherein the liner includes a plurality of flexible fingers.

9. The multiple size member retaining fastener of claim 2, further including first, second and third engagement teeth positioned between the first and second side walls and oppositely positioned across the passageway from the first and second hinge pins, the first clamp arm including a tooth engagement member independently ratcheting into engagement with one of the first, second or third engagement teeth to lock a member between the first and second clamp arms.

10. The multiple size member retaining fastener of claim 9:
wherein contact between the tooth engagement member and the first engagement tooth corresponds to the member defined as a large diameter tube;
wherein contact between the tooth engagement member and the second engagement tooth corresponds to the member defined as a medium diameter tube; and
wherein contact between the tooth engagement member and the third engagement tooth corresponds to the member defined as a small diameter tube.

11. The multiple size member retaining fastener of claim 1, wherein both the member receiving position and the member retention position of the first clamp arm are located within the passageway.

12. A multiple size member retaining fastener, comprising:
a body having a passageway created through opposed first and second body side walls and a cavity between the first and second body side walls; and
a clamp assembly rotatably connected to the first and second side walls and movable in the cavity between the first and second side walls, the clamp assembly including:
a curved first clamp arm rotatable from a member receiving position to a member retention position, both positions located within the passageway;
a second clamp arm oppositely curved with respect to the first clamp arm and rotatable from a release position located outside the passageway to a clamping position located within the passageway;
an arm hinge integrally connecting the first clamp arm to the second clamp arm operating to permit the first and second clamp arms to rotate independently of each other; and
first and second hinge pins extending from the clamp assembly and individually rotatably received in one of the first or second side walls, a common longitudinal rotational axis of the first and second hinge pins also defining a rotational axis of the arm hinge.

13. The multiple size member retaining fastener of claim 12, wherein the second clamp arm is independently rotatable with respect to the first clamp arm using a clamp arm hinge integrally and rotatably connecting the first clamp arm to the second clamp arm.

14. The multiple size member retaining fastener of claim 13, wherein the body includes a wall face oppositely positioned across the passageway with respect to the first and second hinge pins.

15. The multiple size member retaining fastener of claim 14, further including a toothed member fixed to the wall face, the toothed member having multiple teeth positioned on a common radius of curvature.

16. The multiple size member retaining fastener of claim 15, wherein the second clamp arm includes a tooth engagement member sequentially engaging individual ones of the teeth to ratchet closed the first and second clamp arms about the member.

17. The multiple size member retaining fastener of claim 15, wherein an origin of the radius of curvature of the multiple teeth is aligned with an axis of rotation of both the first and second clamp arms.

18. A multiple size member retaining fastener, comprising:
a body having a passageway created through opposed first and second body side walls, the passageway receiving one of multiple members each having different diameters, and a cavity between the first and second body side walls; and
a clamp assembly rotatably connected to the first and second side walls and movable in the cavity between the first and second side walls, the clamp assembly including:
a curved first clamp arm rotatable from a member receiving position to a member retention position, both located within the passageway;
a second clamp arm oppositely curved with respect to the first clamp arm and rotatable from a release position located outside the passageway to a clamping position located within the passageway;
a hinge integrally connecting the first clamp arm to the second clamp arm operating to permit the first and second clamp arms to rotate independently of each other; and
first and second hinge pins extending from the clamp assembly, individually rotatably received in one of the first or second side walls, a common longitudinal rotational axis of the first and second hinge pins also defining a rotational axis of the hinge;
both the first and second clamping arms contacting the one of the members to frictionally retain the one of the members in the passageway when the first clamp arm receives the one of the members in the retention position and the second clamp arm is rotated to the clamping position.

19. The multiple size member retaining fastener of claim 18, further including a toothed member fixed to a wall face of the body oppositely positioned about the passageway with respect to the first and second hinge pins, the toothed member having multiple teeth positioned on a common radius of curvature.

20. The multiple size member retaining fastener of claim 19, wherein the first and second clamp arms each include a tooth engagement member sequentially engaging individual ones of the teeth to ratchet closed the first and second clamp arms about the member.

21. The multiple size member retaining fastener of claim 19, wherein an origin of the radius of curvature of the multiple teeth is aligned with an axis of rotation of both the first and second clamp arms.

22. The multiple size member retaining fastener of claim 18, wherein each of the first and second side walls includes a pin receiving aperture rotatably receiving one of the first or second hinge pins.

23. The multiple size member retaining fastener of claim 18, wherein the first and second clamp arms each include an integrally connected liner of an elastically deflectable material on a concave shaped side of the clamp arms.
